(19) United States
(12) Patent Application Publication
(10) Pub. No.: US 2020/0346378 A1
(43) Pub. Date: Nov. 5, 2020

(54) VARIABLE DEVICE AND METHOD FOR APPLYING A FOAMABLE REACTION MIXTURE TO A MOVING COVER LAYER

(71) Applicant: Covestro Deutschland AG, Leverkusen (DE)

(72) Inventors: Hartmut Nefzger, Pulheim (DE); Uwe Kuenzel, Leverkusen (DE); Michael Schedler, Leverkusen (DE); Christian Hahn, Leverkusen (DE)

(21) Appl. No.: 16/758,628

(22) PCT Filed: Nov. 12, 2018
(86) PCT No.: PCT/EP2018/080922

§ 371 Date: Apr. 23, 2020

(30) Foreign Application Priority Data
Nov. 14, 2017 (EP) 17201523.2

(51) Int. Cl. B29C 44/46; B29C 44/60; B29C 44/32

(52) U.S. Cl. CPC B29C 44/461; B29K 2075/00; B29C 44/321; B29C 44/60

(57) ABSTRACT

The invention relates to a device for applying a foamable reaction mixture to a moving cover layer, comprising a mixing head (100) having at least two inlets (200, 300) and at least one outlet (400) for mixing components that produce the foamable reaction mixture, and a conduit (410, 420, 430, 440) connected to the outlet of the mixing head, through which conduit the foamable reaction mixture can flow, and which has a discharge element (500), from which the foamable reaction mixture can be applied to the cover layer. The conduit (410, 420, 430, 440) is designed to include at least two configurations, which differ in the path length, which the reaction mixture flowing through the conduit covers. The invention further relates to a method for applying a foamable reaction mixture to a moving cover layer using a device according to the invention.

The present invention relates to an apparatus for applying a foamable reaction mixture to a moving outerlayer, comprising a mixing head having at least two inlets and at least one outlet for mixing components forming the foamable reaction mixture and a conduit connected to an outlet of the mixing head through which the foamable reaction mixture can flow and which has a discharging element from which the foamable reaction mixture may be applied to the outerlayer. The invention further relates to a process for applying a foamable reaction mixture to a moving outerlayer using an apparatus according to the invention.

Composite elements made of an outerlayer and an insulating core are currently employed in many industry sectors. The basic construction of such composite elements consists of an outerlayer onto which an insulating material is applied. Employable outerlayers include for example sheets of coated steel, stainless steel, aluminum, copper or alloys of the two latter metals. Insulation panels made of a combination of outerlayers and an insulating core may also be produced. Plastics films, aluminum films, wood, glass fiber or mineral fiber nonwovens and also cellulose-containing materials such as paper, cardboard or papier-mâché may be used as outerlayer materials. Multilayered outerlayers made of aluminum and paper for example are often used. The choice of suitable outerlayer material depends on the intended field of application of the composite elements or insulation panel and the resulting material requirements. Employable insulating cores include in particular foams based on polyurethane (PUR) and/or polyisocyanurate (PIR).

Insulation panels are often employed in the construction of houses or apartments. In addition to the use of composite elements for insulation of chilled warehouses for example they are also ever more frequently employed as façade elements of buildings or as elements of industrial doors such as for example sectional doors. Such composite elements, also referred to hereinbelow as sandwich composite elements, exhibit through their outerlayer a stability and surface appearance corresponding to the material employed while the applied foam confers corresponding thermal insulation properties.

To produce corresponding insulation panels or composite elements a foaming reaction mixture is applied to a provided outerlayer by means of an application apparatus. When using foams based on isocyanates for example the corresponding polyol components and isocyanate components are mixed with one another and applied onto the outerlayer upon which they undergo foaming and curing.

Apparatuses and processes for producing composite elements having an outerlayer and an insulating core are described for example in the following patent applications: WO 2008/104492, WO 2015/150304, WO 2014/124824, CA 2880780, DE 20 2011 001109, US 2014/227441, EP 2 614 944, WO 2013/107739, EP 2 411 198, EP 2 393 643, EP 1 857 248, EP 1 593 438 and DE 2038253.

GB 2 035 887 A describes an apparatus for applying a foamable reaction mixture to a moving outerlayer but it is not apparent from the description and from the drawings in this document that a conduit is adapted to encompass at least two configurations which differ in the path length traversed by the reaction mixture flowing through the conduit.

Irrespective of the different application techniques described hereinabove the prior art has not yet disclosed a solution to the problem of adjusting the viscosity of the reacting melt without altering the formulation. The problem addressed by the present invention is that of at least partly overcoming the disadvantages in the prior art. The problem addressed is in particular that of providing an apparatus and a process in which the delay time of the reaction mixture (the time that elapses between production of the reacting melt in the mixing head and the application thereof to an outerlayer) may be varied.

This problem is solved by an apparatus for applying a foamable reaction mixture to a moving outerlayer according to claim 1 and a process for applying a foamable reaction mixture to a movable outerlayer according to claim 6. Advantageous developments are specified in the subsidiary claims. They may be combined as desired, unless the opposite is unambiguously apparent from the context.

The apparatus for applying a foamable reaction mixture to a moving outerlayer comprises:
a mixing head having at least two inlets and at least one outlet for mixing components forming the foamable reaction mixture and
a conduit connected to an outlet of the mixing head through which the foamable reaction mixture can flow and which has a discharging element from which the foamable reaction mixture may be applied to the outerlayer.

The conduit is adapted to encompass at least two configurations which differ in the path length traversed by the reaction mixture flowing through the conduit.

The process for applying a foamable reaction mixture to a moving outerlayer comprises the steps of:
providing an application apparatus, wherein the application apparatus is an apparatus according to the present invention;
choosing the foamable reaction mixture; wherein the reaction mixture exhibits a change in its viscosity over time;
determining a desired viscosity of the reaction mixture at the time of application to the outerlayer;
configuring the application apparatus such that the path length of the conduit correlates with the desired viscosity of the reaction mixture at the time of application to the outerlayer;
providing the reaction mixture in the mixing head of the application apparatus;
moving the reaction mixture from the mixing head through the conduit and out of the discharging element of the application apparatus onto the outerlayer.

Suitable reaction mixtures include in particular a mixture which reacts to afford a polyurethane and/or polyisocyanurate foam. Suitable outerlayers or substrates include for example metal films, in particular aluminum films, multilayer outerlayers, for example made of aluminum and paper, and plastics films. Nonwovens may also be employed. There is generally no limitation on the width of the outerlayer. For example the outerlayer may have a width between 1000 and 1300 mm, but a width of 2400 mm is also possible. The outerlayer speed is for example ≥1 to ≤70 meters per minute, preferably ≥15 meters per minute, more preferably ≥30 meters per minute.

One constituent of the apparatus is a mixing head which mixes at least two input streams and from which the mixture exits as at least one output stream. The mixing head may be a static mixer. The high-pressure mixing heads known in polyurethane technology are particularly preferred.

The output stream exits the actual mixing head and is then in a conduit having a discharging element. Finally the output stream exits the apparatus according to the invention via this discharging element and contacts the outerlayer. The discharging element may be for example a simple discharging opening, a rake applicator or a slot die. The conduit may be either rigid or flexible and is preferably constructed from a thermoplastic polymer such as for example nylon-6, nylon-6,6, polyethylene, polypropylene, polyvinyl chloride, etc.

The length of the path traversed by the output stream in the conduit from the outlet of the mixing head to the discharging element together with the flow rate of the output stream in the conduit results in a delay time of the reaction mixture in the conduit during which the reaction in the reaction mixture can already take place. Varying the path length then makes it possible to influence the reaction advancement, and thus also the viscosity, with which the reaction mixture is applied to the outer layer.

For example it may be advantageous to shorten the apparent cream time of a polyurethane foam, wherein the apparent cream time is to be understood as meaning the time elapsed between discharging of the reacting polyurethane reaction mixture from the discharging element and commencement of the foaming process. According to the present invention this is achieved when the reacting polyurethane melt is pre-reacted in a delay time element (the conduit of variable length) and is therefore applied onto outerlayers with an already elevated viscosity, i.e. with an apparently shortened cream time.

Such an approach is of particular advantage especially when profiled sheet metals are to be foam-coated without material accumulation in the depressions (ribbings).

It further allows advantageous foam-coating of diffusible outerlayers, for example mineral fleeces, with reduced penetration.

The use of the delay time paths according to the invention furthermore allows catalyst savings to be made.

The process according to the invention is performed using the application apparatus according to the invention. The correlation between the path length of the conduit with the desired viscosity of the reaction mixture may be carried out by initially plotting (for example in a reaction viscometer) the change in viscosity over time after combining the reactants to afford the reaction mixture. With knowledge of the rate of material transport dm/dt in the conduit the required path length may then be easily determined.

In one embodiment of the process according to the invention the reaction mixture comprises ≥20% by weight of a component having a viscosity at 25° C. (rotational viscometry according to DIN 53019) of ≤2500 mPas, preferably ≤1500 mPas, particularly preferably ≤700 mPas and very particularly preferably ≥50 mPas to ≤650 mPas. The present invention in particular allows advantageous employment of low-viscosity polyols and/or low-viscosity polyisocyanates without adjustment of the formulation.

In a further embodiment of the process according to the invention the reaction mixture comprises a polyol, a polyisocyanate, optionally additives such as for example stabilizers and catalysts, optionally one or more flame retardants and one (or more) blowing agents.

The polyol is preferably selected from the group of the polyether polyols, polyester polyols, polycarbonate polyols and/or polyether ester polyols. The OH number of the employed polyol or of the employed polyols may be for example >100 mg KOH/g to <800 mg KOH/g and the average OH functionality of the employed polyol or of the employed polyols is ≥2. In the case of a single added polyol the OH number indicates the OH number of said polyol. In the case of mixtures the average OH number is reported. This value may be determined in accordance with DIN 53240. The average OH functionality of the polyols is for example in a range from ≥2 to <6.

Employable polyether polyols are for example polytetramethylene glycol polyethers such as are obtainable by polymerization of tetrahydrofuran by cationic ring opening. Likewise suitable polyether polyols are addition products of styrene oxide, ethylene oxide, propylene oxide, butylene oxide and/or epichlorohydrin onto di- or polyfunctional starter molecules. Polyether polyols predominantly constructed of propylene oxide and ethylene oxide are usually used.

Suitable starter molecules are for example ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and low molecular weight hydroxyl-containing esters of such polyols with dicarboxylic acids.

Employable polyester polyols include inter alia polycondensates of di- and also tri- and tetraols and di- and also tri- and tetracarboxylic acids or hydroxycarboxylic acids or lactones. Also employable for producing the polyesters instead of the free polycarboxylic acids are the corresponding polycarboxylic anhydrides or corresponding polycarboxylic esters of lower alcohols.

Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as the acid source. It will be appreciated that similarly to the polycarboxylic acids the polyols may be of biogenic origin and/or have been obtained by fermentative means.

If polyols and/or polycarboxylic acids having functionalities >2 are co-used in the synthesis of the polyester polyols the functionality may also be adapted by employing proportions of monofunctional carboxylic acids, for example fatty acids, for instance oleic acid, and monofunctional alcohols such as for example oleyl or stearyl alcohol. Hydroxycarboxylic acids that may be co-used as reaction participants in the production of a polyester polyol having terminal hydroxyl groups are for example ricinoleic acid, hydroxycaproic acid, hydroxybutyric acid, hydroxydecanoic acid, hydroxystearic acid and the like. Suitable lactones are inter alia caprolactone, butyrolactone and homologs.

Polycarbonate polyols that may be used are hydroxyl-containing polycarbonates, for example polycarbonate diols. These are obtainable by reaction of carbonic acid derivatives, such as diphenyl carbonate, dimethyl carbonate or phosgene, with polyols, preferably diols, or from carbon dioxide and alkylene oxides.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, and lactone-modified diols of the aforementioned type. Polyether polycarbonate diols may also be employed instead of or in addition to pure polycarbonate diols.

Employable polyether ester polyols are compounds containing ether groups, ester groups and OH groups. Organic dicarboxylic acids are useful for producing the polyetherester polyols, preferably aliphatic dicarboxylic acids having ≥3 to ≤16 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isophthalic acid. Derivatives of these acids that may be used include, for example, their anhydrides and also their esters and monoesters with low molecular weight monofunctional alcohols having ≥1 to ≤4 carbon atoms.

Examples of suitable polyisocyanates are 1,4-butylene diisocyanate, 1,5-pentane diisocyanate, 1,6-hexamethylene diisocyanate (HDI), isophorone diisocyanate (IPDI), 2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) or higher homologs (polymeric MDI, pMDI), 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1 to C6-alkyl groups.

In addition to the abovementioned polyisocyanates, it is also possible to use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

In the reaction mixture the ratio of the number of NCO groups in the isocyanate to the number of isocyanate-reactive groups multiplied by 100, known as the index, may be in the range from 110 to 600. Preferably between 115 and 400. This index may also be in a range from >180:100 to <330:100 or else >90:100 to <140:100.

Suitable blowing agents may include physical blowing agents such as n-pentane, cyclopentane, isopentane, propane or butane or blends thereof or carbon dioxide. Also employable are fluorinated olefins such as for example Chemours 1100 or Solstice LBA or additives such as FA 188 from 3M. Chemical blowing agents such as water or formic acid may also be employed. A combination of physical and chemical blowing agents is likewise possible.

In a further embodiment of the process according to the invention the reaction mixture contains an amine catalyst and for a predetermined value of the viscosity of the reaction mixture upon exiting the discharging element the content of the amine catalyst in the reaction mixture for the configuration of the conduit having the longest path length is ≤90% (preferably ≤85%, more preferably ≤80%) of the content in the reaction mixture for the configuration of the conduit having the shortest path length.

The amine catalysts are preferably selected from the group of aliphatic tertiary amines and quaternary ammonium salts.

Suitable amine catalysts are for example pentamethyldiethylenetriamine, N,N-dimethylcyclohexylamine or the quaternary ammonium salts obtainable from Air Products/Evonik under the trade names Dabco TMR-3, -4 and -5 as well as for example triethylenediamine, triethylamine, tributylamine, N,N,N′,N′-tetramethylethylenediamine, N,N,N′,N′-tetramethylbutanediamine, tetramethylhexanediamine, N-methylmorpholine, N-ethylmorpholine, N-cyclohexylmorpholine, triethanolamine, N-methyldiethanolamine, N-ethyldiethanolamine, triisopropanol amine.

The present invention preferably contemplates a usage amount of the catalysts pentamethyldiethylenetriamine, N,N-dimethylcyclohexylamine or the quaternary ammonium salts marketed by Air Products/Evonik under the trade names Dabco TMR-3, -4 and -5 that is reduced compared to an application technique without a delay time element.

Furthermore, in the case of Desmorapid DB (N,N-dimethylbenzylamine) the content for the longest configuration is 90% of the content in the shortest configuration, for DMCHA (N,N-dimethylcyclohexylamine) 80% and for Desmorapid PV (bis(2-dimethylaminoethyl)methylamine) 66%.

In a further embodiment of the process according to the invention the path length of the conduit is altered during application of the reaction mixture. Thus the delay time may be adapted during continuous operation of the process.

The present invention is more particularly elucidated with reference to the figures which follow without, however, being limited thereto.

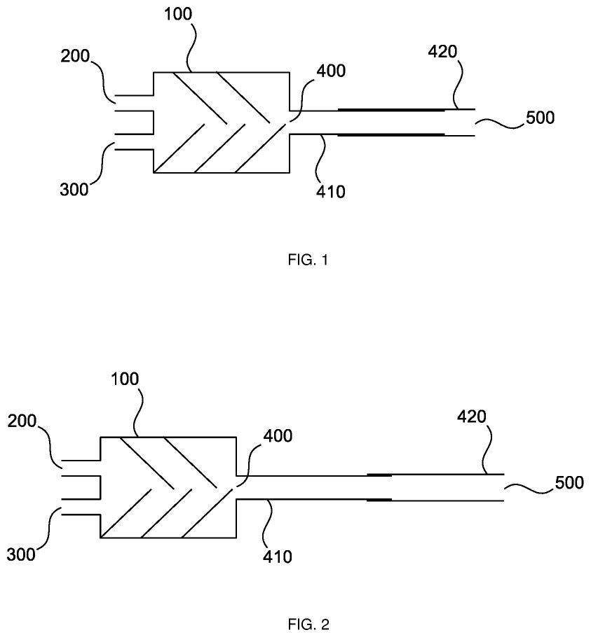

FIG. 1 shows a first apparatus according to the invention in a first configuration

FIG. 2 shows the first apparatus according to the invention in a second configuration

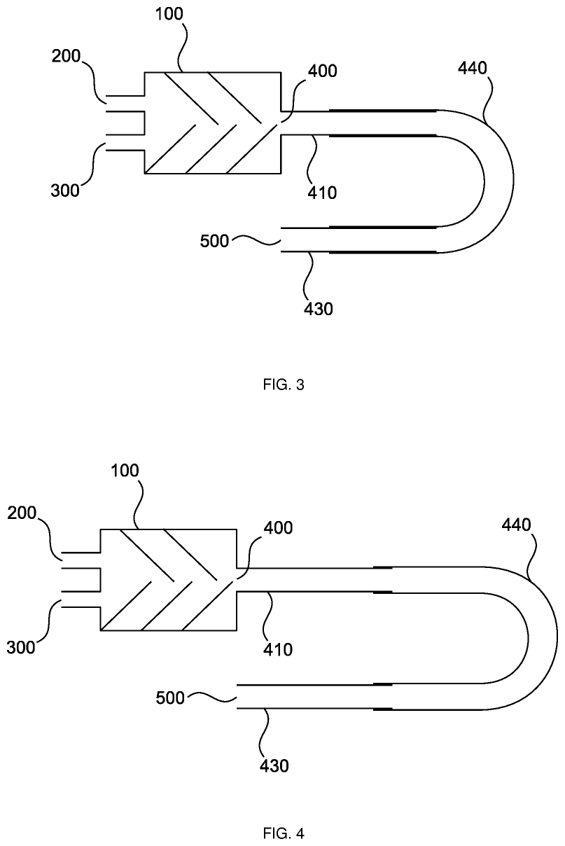

FIG. 3 shows a second apparatus according to the invention in a first configuration

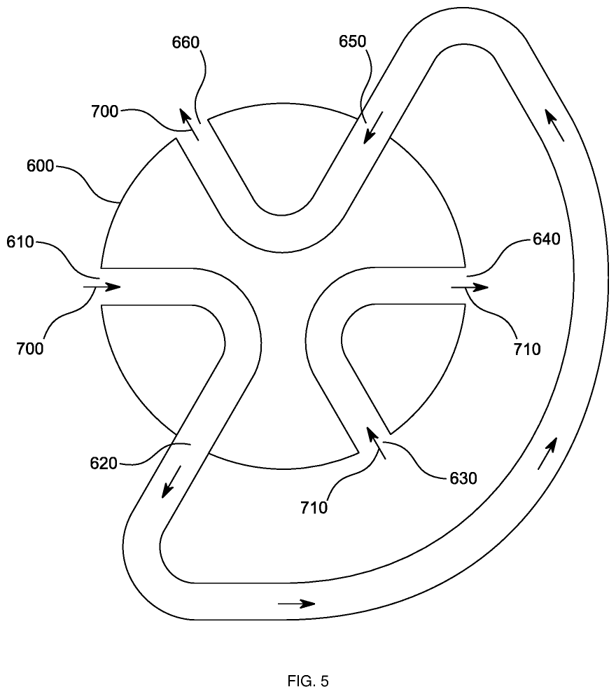

FIG. 4 shows the first apparatus according to the invention in a second configuration

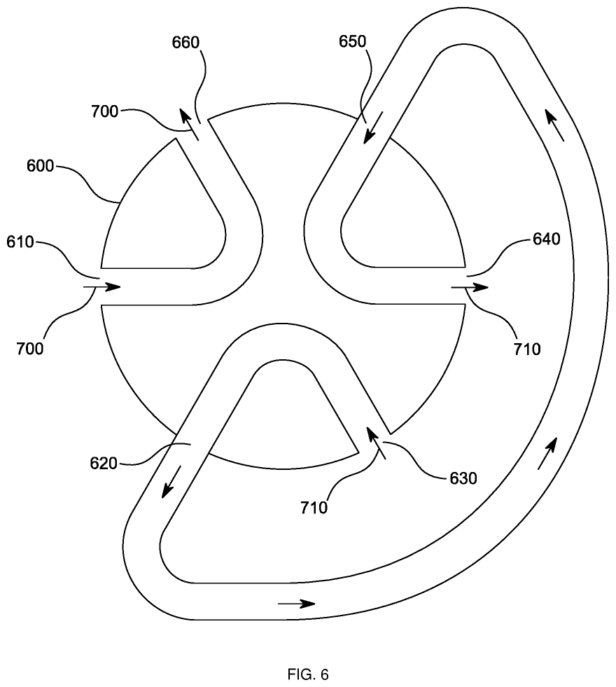

FIG. 5 shows a detail view of a third apparatus according to the invention in a first configuration

FIG. 6 shows a detail view of the third apparatus according to the invention in a second configuration

In one embodiment of the apparatus according to the invention the conduit is adapted to encompass continuously variable path lengths. This may be achieved for example when the conduit has an inner part and a coaxial outer part arranged over the inner part and the inner part and the outer part are movable with respect to one another along their common axis. Such a variant is shown in FIGS. 1 and 2.

FIG. 1 shows a first apparatus according to the invention having a mixing head 100 comprising two inlets 200, 300 and an outlet 400. The mixing head is presently in the form of a static mixer and may be used for example to mix a polyol stream and an isocyanate stream to obtain a reaction mixture reacting to afford a PUR/PIR foam. The conduit connected to the outlet 400 of the mixing head 100 has an inner part 410 which initially receives the reaction mixture flowing from the outlet 400. An outer part 420 fits coaxially around the inner part 410. Parts 410 and 420 are movable along their common axis.

Optional seals (not shown) can prevent discharge of reaction mixture through any gap present between parts 410 and 420. The end 500 of the outer part 420 opposite the outlet 400 forms the discharging element of the apparatus. A discharging element such as a rate applicator or a slot die may alternatively be attached to the end 500.

The apparatus in FIG. 1 is configured for a relatively short delay time path. Pulling apart the outer part 420, as shown in FIG. 2, allows a longer delay time path to be realized. It is readily apparent that the delay time path is continuously variable.

FIG. 3 shows a second first apparatus according to the invention having a mixing head 100 comprising two inlets 200, 300 and an outlet 400. The mixing head is presently in the form of a static mixer and may be used for example to mix a polyol stream and an isocyanate stream to obtain a reaction mixture reacting to afford a PUR/PIR foam. The conduit connected to the outlet 400 of the mixing head 100 has an inner part 410 which initially receives the reaction mixture flowing from the outlet 400. A straight section of an outer part 440 fits coaxially around the inner part 410. Parts 410 and 440 are movable along their common axis. The outer part comprises a U-bend and further fits coaxially around the second inner part 430 of the conduit. This arrangement is comparable to a slide trombone.

Optional seals (not shown) can prevent discharge of reaction mixture through any gap present between parts 410, 430 and 440. The end 500 of the second inner part 430 forms the discharging element of the apparatus. A discharging element such as a rate applicator or a slot die may alternatively be attached to the end 500.

FIG. 4 shows the apparatus from FIG. 3 in which the delay time path has been enlarged by moving the outer part 440.

In a further embodiment of the apparatus according to the invention the conduit is adapted to encompass a plurality (for example 2, 3, 4, 5, 6 or 7) of discrete configurations each having a different path length. This may be effected for example when the apparatus at least partially passes through a multiport valve. Such a variant is shown in FIGS. 5 and 6.

FIG. 5 shows a 6-way valve or 6-way cock as a detail view of an apparatus according to the invention. The valve comprises three pairs of openings fluidically connected to one another by channels: openings 610/620, openings 630/640 and openings 650/660.

In the configuration shown in FIG. 5 of a long delay time path, material stream 700 which comes directly or indirectly from the mixing head enters inlet 610, exits through inlet 620, passes through the external conduit up to inlet 650 and exits the valve via inlet 660 to be applied to the outerlayer in the process via a discharging element. The material stream 710 may be for example a solvent for rinsing the valve and enters the valve via inlet 630 and exits the valve again via inlet 640.

To shorten the delay time path the valve shown in FIG. 5 may be rotated by 60°, thus leaving unchanged the position of the external conduit previously traversed by material stream 700. This new configuration is shown in FIG. 6.

In FIG. 6 the material stream 700 comprising the reaction mixture takes the short path in through inlet 610 and out of the valve through inlet 660. Material stream 710, once more in the form of a solvent for rinsing for example, enters the valve via inlet 630, exits said valve via inlett 620, traverses the external conduit, reenters the valve via inlet 650 and finally exits said valve via inlet 640.

It will be appreciated that two or more multiport cocks may also be connected in series, thus avoiding a return to a configuration lacking a delay time element.

It will further be appreciated that embodiments such as are described in connection with FIGS. 1 to 4 may also be combined with the multiport cock.

1. An apparatus for applying a foamable reaction mixture to a moving outerlayer, comprising:
a mixing head having at least two inlets and at least one outlet for mixing components forming the foamable reaction mixture; and
a conduit connected to an outlet of the mixing head through which the foamable reaction mixture can flow and which has a discharging element from which the foamable reaction mixture may be applied to the outerlayer, wherein
the conduit is adapted to encompass at least two configurations which differ in the path length traversed by the reaction mixture flowing through the conduit.

2. The apparatus as claimed in claim 1, wherein the conduit is adapted to encompass continuously variable path lengths.

3. The apparatus as claimed in claim 2, wherein the conduit has an inner part and a coaxial outer part arranged over the inner part, and the inner part and the outer part are movable with respect to one another along their common axis.

4. The apparatus as claimed in claim 1, wherein the conduit is adapted to encompass a plurality of discrete configurations each having different path lengths.

5. The apparatus as claimed in claim 4, wherein the conduit at least partially passes through a multiport valve.

6. A process for applying a foamable reaction mixture that exhibits a change in its viscosity over time to a moving outerlayer, comprising:
determining a desired viscosity of the reaction mixture at the time of application to the outerlayer;
configuring the application apparatus of claim 1 such that the path length of the conduit correlates with the desired viscosity of the reaction mixture at the time of application to the outerlayer;
providing the reaction mixture in the mixing head of the application apparatus; and
moving the reaction mixture from the mixing head through the conduit and out of the discharging element of the application apparatus onto the outerlayer.

7. The process as claimed in claim 6, wherein the reaction mixture comprises ≥20% by weight of a component having a viscosity measured at 25° C. by rotational viscometry according to DIN 53019 of ≤2500 mPas.

8. The process as claimed in claim 6, wherein the reaction mixture comprises a polyol, a polyisocyanate and a blowing agent.

9. The process as claimed in claim 8, wherein the reaction mixture contains an amine catalyst and for a predetermined value of the viscosity of the reaction mixture upon exiting the discharging element, the content of the amine catalyst in the reaction mixture for the configuration of the conduit having the longest path length is ≤90% of the content in the reaction mixture for the configuration of the conduit having the shortest path length.

10. The process as claimed in claim 6, wherein the path length of the conduit is altered during application of the reaction mixture.
